(19) United States
(12) Patent Application Publication
(10) Pub. No.: US 2026/0105721 A1
(43) Pub. Date: Apr. 16, 2026

(54) SIGNAL PROCESSING CIRCUIT, SIGNAL PROCESSING METHOD, AND PROGRAM

(71) Applicant: Sony Interactive Entertainment Inc., Tokyo (JP)

(72) Inventors: Masayoshi MIZUNO, Tokyo (JP); Kiyotsugu ARAI, Kanagawa (JP)

(73) Assignee: Sony Interactive Entertainment Inc., Tokyo (JP)

(21) Appl. No.: 19/115,790

(22) PCT Filed: Oct. 5, 2022
(86) PCT No.: PCT/JP2022/037227

§ 371 Date: Mar. 27, 2025

(51) Int. Cl. G06V 10/75; G06V 10/20; G06V 10/26

(52) U.S. Cl. CPC G06V 10/753; G06V 10/255; G06V 10/26

(57) ABSTRACT

A signal processing circuit that processes event signals generated by an event-based vision sensor (EVS). The signal processing circuit includes a memory configured to store program code and a processor configured to execute operations according to the program code. The operations include detecting at least one line segment or curve that is formed by a set of positions within a block of the event signals generated in a block obtained upon division of a detection area of the EVS, and correcting at least one of a first line segment or a first curve or at least one of a second line segment or a second curve in such a manner that a first endpoint of the first line segment or first curve detected in a first block overlaps with a second endpoint of the second line segment or second curve detected in a second block adjacent to the first block.

### TECHNICAL FIELD

The present invention relates to a signal processing circuit, a signal processing method, and a program.

### BACKGROUND ART

An event-based vision sensor (EVS) is known in which a pixel generates a signal asynchronously in a case where the pixel detects a change in intensity of incident light. The EVS is also called an EDS (Event Driven Sensor), an event camera, or a DVS (Dynamic Vision Sensor), and includes a sensor array that is formed by sensors including light-receiving elements. Upon detecting a change in the intensity of the incident light, more specifically, a luminance change of the surface of an object, the EVS 110 generates a timestamp, sensor identification information, and information regarding polarity of the luminance change. When compared to frame-based vision sensors that scan all pixels at predetermined intervals, specifically image sensors such as charge-coupled devices (CCDs) and complementary metal-oxide-semiconductors (CMOSs), the EVS has advantage of being able to operate at high speed with low power consumption. Such EVS-related technologies are described, for example, in PTL 1 and PTL 2.

### CITATION LIST

### Patent Literature

[PTL 1]
National Publication of International Patent Application No. 2014-535098

### [PTL 2]

Japanese Patent Laid-open No. 2018-85725

### SUMMARY

### Technical Problem

However, since the knowledge of methods used by the frame-based vision sensors to process signals generated by the vision sensors has been accumulated, the event signals generated by the EVS have tended to be also bit-mapped, namely, two-dimensionalized, for processing purposes. In such a case, processing has been performed with redundant information added to the asynchronously generated event signals. As a result, the rapidity of EVS operations has not been fully utilized.

In view of the above circumstances, the present invention has been made to provide a signal processing circuit, a signal processing method, and a program that are able to more rapidly process the event signals generated by the EVS.

### Solution to Problem

According to an aspect of the present invention, there is provided a signal processing circuit that processes event signals generated by an event-based vision sensor (EVS). The signal processing circuit includes a memory configured to store program code and a processor configured to execute operations according to the program code. The signal processing circuit performs operations including detecting at least one line segment or curve formed by a set of positions within a block of event signals generated in a block obtained upon division of a detection area of the EVS, and correcting at least one of a first line segment or a first curve or at least one of a second line segment or a second curve in such a manner that a first endpoint of the first line segment or first curve detected in a first block overlaps with a second endpoint of the second line segment or second curve detected in a second block adjacent to the first block.

According to another aspect of the present invention, there is provided a signal processing method for processing event signals generated by an event-based vision sensor (EVS). The signal processing method causes a processor to execute operations according to program code stored in a memory. The operations include detecting at least one line segment or curve formed by a set of positions within a block of event signals generated in a block obtained by dividing a detection area of the EVS, and correcting at least one of a first line segment or a first curve or at least one of a second line segment or a second curve in such a manner that a first endpoint of the first line segment or first curve detected in a first block overlaps with a second endpoint of the second line segment or second curve detected in a second block adjacent to the first block.

According to yet another aspect of the present invention, there is provided a program for processing event signals generated by an event-based vision sensor (EVS). Operations executed by a processor according to the program include detecting at least one line segment or curve formed by a set of positions within a block of event signals generated in a block obtained by dividing a detection area of the EVS, and correcting at least one of a first line segment or a first curve or at least one of a second line segment or a second curve in such a manner that a first endpoint of the first line segment or first curve detected in a first block overlaps with a second endpoint of the second line segment or second curve detected in a second block adjacent to the first block.

### BRIEF DESCRIPTION OF DRAWINGS

FIG. 1 is a diagram illustrating an outline of a configuration of a signal processing circuit according to an embodiment of the present invention.

FIG. 2 is a schematic diagram illustrating the examples of blocks and events.

FIG. 3 is a diagram for explaining an example of line segment detection in an example depicted in FIG. 1.

FIG. 4 is a diagram for conceptually explaining a process of correcting a detected line segment.

FIG. 5 is a diagram for conceptually explaining a process of correcting a detected line segment.

FIG. 6 is a flowchart illustrating an example of processing performed to correct a line segment detected in the example depicted in FIG. 1.

FIG. 7 is a diagram illustrating another example of detecting a shape that is formed by a set of event signal positions.

FIG. 8 is a diagram for explaining an example of processing performed using parameters representing a relation between the event signal positions within the blocks.

### DESCRIPTION OF EMBODIMENT

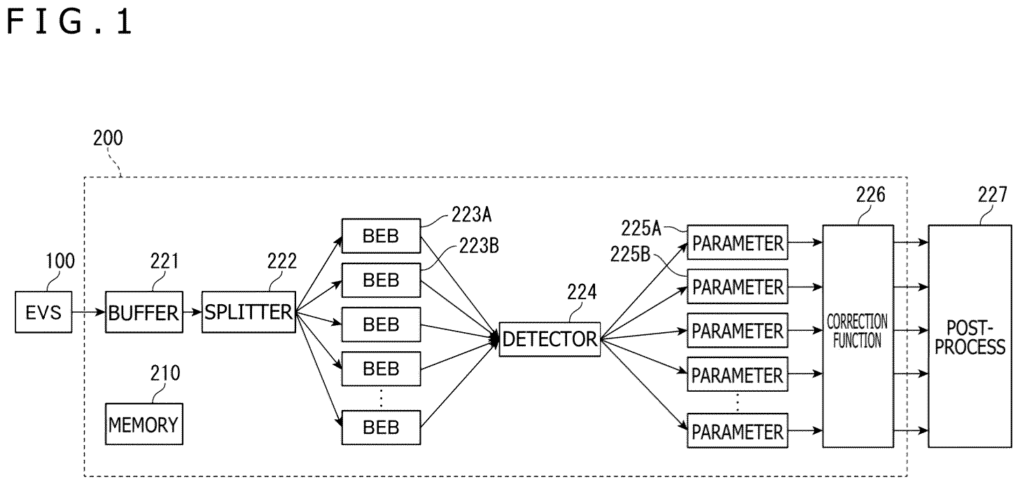

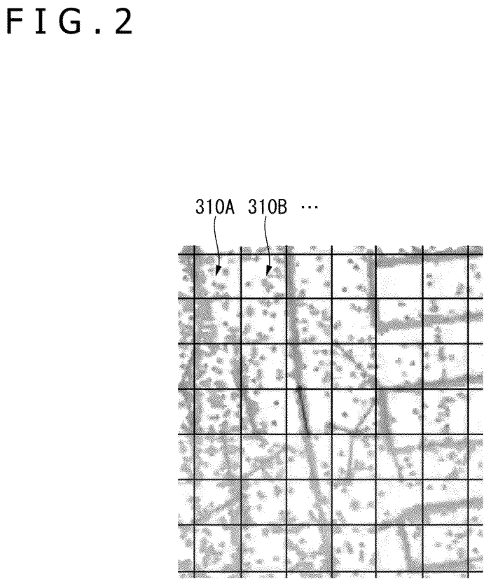

FIG. 1 is a diagram illustrating an outline of a configuration of a signal processing circuit according to an embodiment of the present invention. A signal processing circuit 200 is configured to process event signals generated by an event-based vision sensor (EVS) 100, and formed by processing circuits, such as a CPU (Central Processing Unit), a DSP (Digital Signal Processor), an ASIC (Application Specific Integrated Circuit), and/or an FPGA (Field-Programmable Gate Array). The signal processing circuit 200 includes a memory 210 that is formed, for example, by various types of ROM (Read Only Memory) and/or RAM (Random Access Memory). The signal processing circuit 200 executes operations as described below according to program codes stored in the memory 210. It should be noted that a post-process 227 may be executed partially or wholly by the signal processing circuit 200, or may be executed by a device or a circuit other than the signal processing circuit 200. The event signals generated by the EVS 100 are temporarily stored in a buffer 221, and are allocated by a splitter 222 to block event buffers (BEBs) 223A, 223B, . . . (hereinafter collectively referred to also as the BEBs 223). In this instance, the splitter 222 allocates the event signals generated in individual grid-shaped blocks 310A, 310B, . . . (hereinafter collectively referred to also as the blocks 310), which are obtained when a detection area of the EVS 100 is divided as depicted, for example, in FIG. 2, to the corresponding BEBs 223A, 223B, . . . . The BEBs 223 are predefined as buffers that temporarily store the event signals corresponding to the individual grid-shaped blocks 310 that are obtained when the detection area of the EVS 100 is divided. In a case where the settings of the blocks 310 are dynamically changed as indicated in a later-described example, the definitions of the BEBs 223 are also dynamically changed according to the settings of the blocks 310. The event signals may include, for example, the position (x, y) in the detection area as information that may additionally include the time “t” of event signal generation. The splitter 222 references the information indicating the position (x, y) to determine the BEBs 223 to which the event signals are to be allocated. As indicated in a later-described example, the splitter 222 may duplicate the event signals and allocate the duplicated event signals to two or more BEBs 223.

The BEBs 223 store the event signals generated in the individual blocks 310. When the event signals are allocated to one of the BEBs 223A, 223B, . . . , a detector 224 detects a line segment from a set of positions (x, y) of the event signals stored in such a BEB 223. In the present embodiment, line segment detection by the detector 224 is an example of detecting an intra-block relation between the positions of the event signals generated in the blocks 310. For example, in a case where an event occurs due to the movement of an object edge within a certain block 310, the set of positions (x, y) of the event signals forms a line segment. Although the object edge is not necessarily straight, the object edge can be approximated as a set of line segments when the grid-shaped blocks 310 are set to appropriate sizes. Incidentally, in this document, a “relation between the event signal positions” is indicated by data that represents the event signal positions in the blocks in a lighter form than a bitmap. Therefore, examples of detecting a relation between the event signal positions in the blocks are not limited to detecting line segments or straight lines, and may include, for instance, detecting certain shapes defined by a finite number of parameters.

The detector 224 detects line segments by using, for example, Hough transform or a method of minimizing the sum of the distances from the positions of individual event signals to the straight lines. It should be noted that these methods directly detect straight lines whose start and endpoints are not identified, and that line segments corresponding to the straight lines are detected by limiting the straight lines to sections within the blocks 310. The detector 224 may detect a plurality of line segments for one block 310 by using, for example, the Hough transform. As indicated in a later-described example, the detector may detect curves from a set of event signal positions (x, y).

More specifically, the detector 224 outputs parameters 225A, 225B, . . . (hereinafter collectively referred to also as the parameters 225) representing the detected line segments. The parameter 225A is information indicating a line segment detected by the detector 224 from an event signal generated in block 310A and stored in the BEB 223A, and the same applies to the parameters 225B and onwards. It should be noted that the parameters 225A, 225B, . . . are not necessarily outputted synchronously, but are outputted asynchronously by a process executed by the detector 224 when the event signal is allocated to one of the BEBs 223 as described above. The outputted parameters 225 are corrected by a correction function 226 and used as information indicating the result of detection by the EVS 100 in the post-process 227. The post-process 227 is executed, for example, for a purpose of detecting the movement of a subject, matching a three-dimensional shape with the subject, or processing a recognizer by using machine learning.

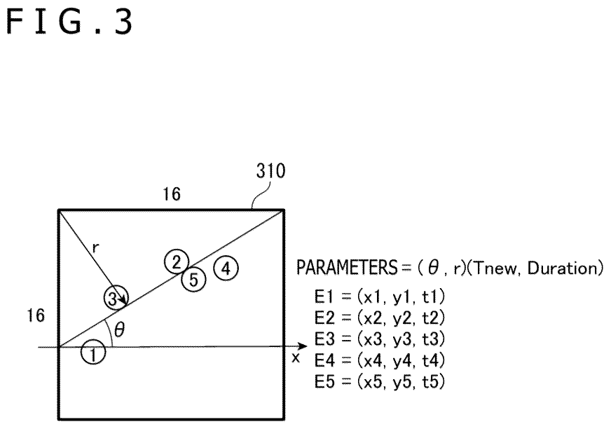

FIG. 3 is a diagram for explaining an example of line segment detection in an example depicted in FIG. 1. As described above, the present embodiment is configured such that, when the event signals are allocated to the block event buffers (BEBs) 223 corresponding to the individual grid-shaped blocks 310, which are obtained when the detection area of the EVS 100 is divided, the detector 224 executes a process of detecting line segments from the set of event signal positions (x, y). In the example depicted in FIG. 3, a process of detecting line segments in a case where five event signals are in the BEBs 223 (the actual number of event signals may be more or less than five) is schematically depicted. Event signals E1 to E5 may each include positions (x1, y1), (x2, y2), (x3, y3), (x4, y4), and (x5, y5) in the detection area as information that may additionally include times t1 to t5, which each indicate the time of generation. Positions (x1, y1), (x2, y2), (x3, y3), (x4, y4), and (x5, y5) all indicate positions within the blocks 310 to be processed. Therefore, if the sizes of the blocks 310 (16 pixels by 16 pixels in the illustrated example) are appropriate, event information need not be bit-mapped. The detector 224 is able to mathematically detect the line segments from the positions (x1, y1), (x2, y2), (x3, y3), (x4, y4), and (x5, y5) of the event signals E1 to E5 stored in the BEBs 223.

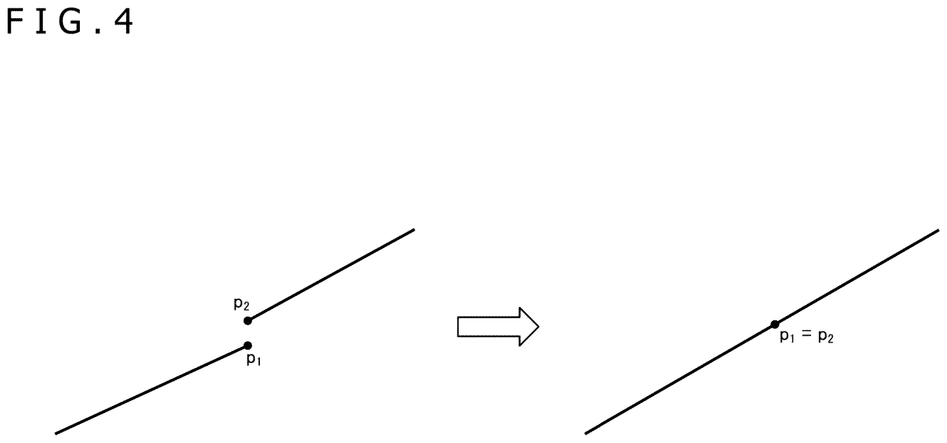

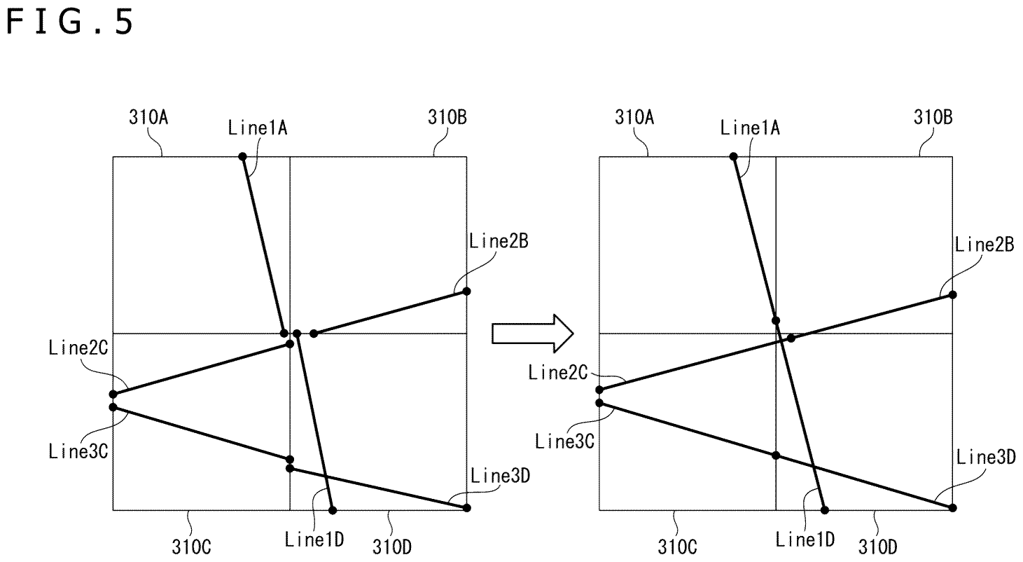

FIGS. 4 and 5 are diagrams for conceptually explaining a process of correcting the detected line segments. As described above, the present embodiment is configured such that, when the grid-shaped blocks 310 are set to appropriate sizes, an event occurring due to an object edge that is not necessarily straight is detected as a set of line segments in each block. In this case, due to the status of event occurrence in each block and the influence of noise, the line segments detected across a plurality of blocks are not necessarily detected as continuous line segments, namely, as straight or broken lines in which the endpoints of the line segments in each block overlap with each other.

Consequently, for line segments that are highly likely to be continuous, the correction function 226 makes a correction so as to move block endpoints p₁ and p₂ as depicted in FIG. 4, so that p₁=p₂. In the example depicted in FIG. 5, line segment (Line) 1A detected in block 310A and line segment 1D detected in block 310D are corrected in such a manner that their endpoints overlap with each other. Similarly, the combination of line segment 2B detected in block 310B and line segment 2C detected in block 310C and the combination of line segment 3C detected in block 310C and line segment 3D detected in block 310D are also corrected in such a manner that their endpoints overlap with each other. As indicated in the example of blocks 310C and 310D, each of a plurality of line segments detected in a block may be corrected in such a manner that its endpoints overlap with another line segment detected in another block.

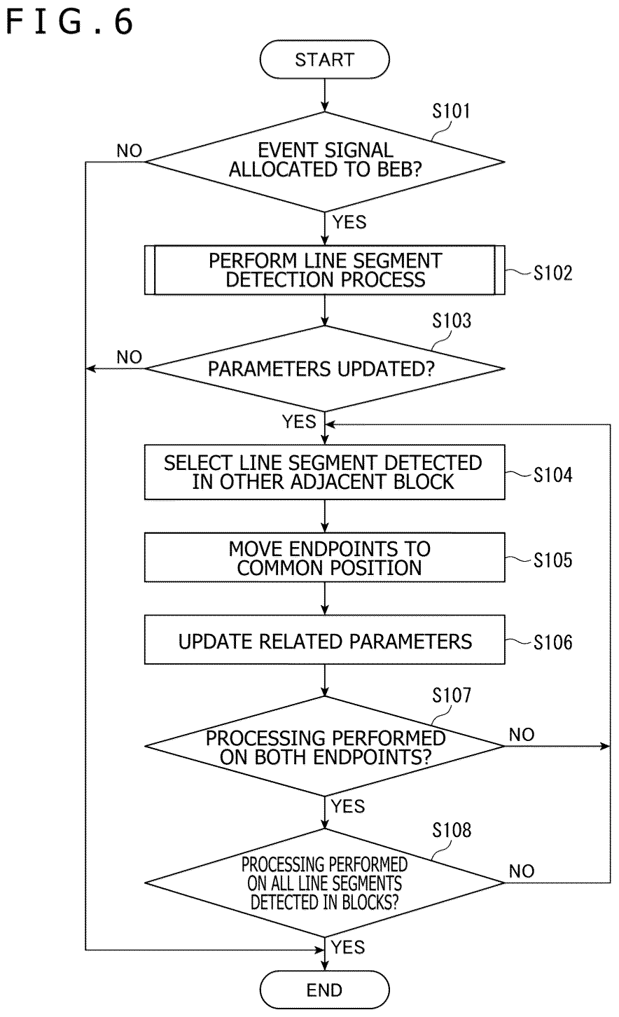

FIG. 6 is a flowchart illustrating an example of processing performed to correct a line segment detected in the example depicted in FIG. 1. As illustrated, when an event signal is allocated to a corresponding block event buffer (BEB) 223 (step S101), the detector 224 executes a process of detecting a line segment (step S102). In step S102, the detector 224 detects a line segment by using, for example, the Hough transform, or determines a line segment in such a manner as to minimize the sum of distances from the event signal positions to the straight lines. The sum of distances from the event signal positions may be, for example, a sum of squares, an absolute sum, or a sum of p-th powers (p is any positive number). The detector 224 may detect a line segment by using, for example, any of the above-mentioned methods in a fixed manner, or may detect a line segment by selectively using a plurality of methods according to the distribution of the event signal positions.

In a case where a line segment is detected in the process performed in step S102 and then the parameters 225 are updated (step S103), the correction function 226 references the parameters 225, and selects a line segment that is among the line segments detected in other blocks adjacent to a block 310 and does not exceed the threshold difference in angle between the line segments and the threshold distance between the line segment endpoints (step S104). In this instance, the line segment to be processed is set as the first line segment, and a line segment selected from the line segments detected in the other blocks is set as the second line segment. The correction function 226 moves the endpoints of the first line segment and the endpoints of the second line segment to a later-described common position (step S105). As a result, the endpoints of the first line segment overlap with the endpoints of the second line segment. The correction function 226 updates the parameters 225 related to a line segment having moved endpoints in such a manner that the line segment passes through the moved endpoints (step S106). More specifically, the correction function 226 updates the parameters 225 of at least one of the first and second line segments.

For example, in a case where the result of common position calculation described below indicates that the common position substantially coincides with the original endpoint of either the first line segment or the second line segment, the correction function 226 may update the parameters 225 in such a manner as to correct only one of the first and second line segments. The above-mentioned processes in steps S104 to S106 are executed for each of the two endpoints of the first line segment (step S107). Further, if a plurality of line segments are detected in one block, the above-mentioned processes in steps S104 to S107 are repeated (step S108).

Examples i) to iii) of moving the line segment endpoints to the common position will now be described. Referring to the examples i) and ii), in a case where the line segments are detected in each block by the same method, the endpoints are moved to positions to be internally divided by a ratio corresponding to the detection method. As a result, the common position of the corrected endpoints becomes closer to the original endpoint position of a more reliable line segment among the line segments detected in each block.

i) in a Case where Both Line Segments are Detected by Using the Hough Transform

In the Hough transform, vote counts v₁ and v₂ are calculated for each detected line segment. The higher the vote counts v₁ and v₂, the higher the reliability of the detected line segments. Therefore, as indicated in Equation (1), the common position of the corrected endpoints is determined by internally dividing the positions p₁ and p₂ of the endpoints of each line segment by the ratio between the vote counts v₁ and v₂ of the line segments to which the endpoints belong.

$$[ Math . 1 ]$$

$${p}_{1} , {p}_{2} ← \frac{{v}_{1} {p}_{1} + {ν}_{2} {p}_{2}}{{v}_{1} + {ν}_{2}} \qquad ( 1 )$$

ii) in a Case where Both Line Segments are Detected by Using a Method of Minimizing the Sum of the Distances from the Event Signal Positions

The reliability of the line segments detected by using a method of minimizing the sum of the distances from the event signal positions can be calculated, for example, by using Equation (2). The smaller eigenvalues λ₁ and λ₂ of the variance-covariance matrix S of the set of event signal positions (xᵢ, yᵢ) (i=0, 2, . . . , N−1) in each block can be used as an indicator of reliability. The smaller eigenvalues λ₁ and λ₂ indicate the degree to which the event signal positions in each block are dispersed in the normal direction of the detected line segments. Therefore, the smaller the smaller eigenvalues λ₁ and λ₂, the higher the reliability of the detected line segments. Therefore, as indicated in Equation (3), the positions p₁ and p₂ of the endpoints of each line segment are internally divided by the inverse ratio between the smaller eigenvalues λ₁ and λ₂ of the variance-covariance matrix in a block in which the line segments are detected, and then the position determined upon internal division is set as the common position of the corrected endpoints. Instead of the inverse ratio between the smaller eigenvalues λ₁ and λ₂, the inverse ratio of the ratio between the large and small eigenvalues r₁ (=λₘᵢₙ₁/λₘₐₓ₁) and r₂ (=λₘᵢₙ₂/λₘₐₓ₂) may be used.

$$[ Math . 2 ]$$

$$\begin{matrix}S = {\sum }_{i = 0}^{N - 1} ( \begin{matrix}{x}_{i} - {μ}_{x} \\ {y}_{i} - {μ}_{y}\end{matrix} ) ( {x}_{i} - {μ}_{x} {y}_{i} - {μ}_{y} ) \\ = ( \begin{matrix}{\sum }_{i = 0}^{N - 1} {( {x}_{i} - {μ}_{x} )}^{2} & {\sum }_{i = 0}^{N - 1} ( {x}_{i} - {μ}_{x} ) ( {y}_{i} - {μ}_{y} ) \\ {\sum }_{i = 0}^{N - 1} ( {x}_{i} - {μ}_{x} ) ( {y}_{i} - {μ}_{y} ) & {\sum }_{i = 0}^{N - 1} {( {y}_{i} - {μ}_{x} )}^{2}\end{matrix} ) \\ = ( \begin{matrix}{S}_{xx} & {S}_{xy} \\ {S}_{xy} & {S}_{yy}\end{matrix} )\end{matrix} \qquad ( 2 )$$

$${p}_{1} , {p}_{2} ← \frac{{λ}_{2} {p}_{1} + {λ}_{1} {p}_{2}}{{λ}_{1} + {λ}_{2}} \qquad ( 3 )$$

iii) in a Case where the Individual Line Segments are Detected by Different Methods

For example, in a case where the detector 224 selectively uses a plurality of methods for line segment detection, there is no common indicator that indicates the reliability of each line segment. Therefore, as indicated in Equation (4), the midpoint of the positions p₁ and p₂ of the endpoints of each line segment is set as the common position of the corrected endpoints.

$$[ Math . 3 ]$$

$${p}_{1} , {p}_{2} ← \frac{{p}_{1} + {p}_{2}}{2} \qquad ( 4 )$$

Here, when the detector 224 detects line segments, for example, an upper limit may be set on the number of event signals stored in the BEBs 223, and the oldest event signal may be deleted when a new event signal is allocated in a FIFO (First In, First Out) manner. Alternatively, a threshold may be set for the difference between the time “t” of an event signal and the processing time or the time “t” of the latest event signal, and the detector 224 may refrain from using an event signal exceeding the threshold difference for line segment detection, or may delete such an event signal from the BEBs 223.

Further, in a case where an event signal having the same position (x, y) as an event signal stored in the BEBs 223 is newly allocated, for example, the time “t” of the stored event signal may be updated with the time “t” of the newly allocated event signal to avoid duplication of event signals having the same positions (x, y) in the BEBs 223. In this case, for example, the speed of calculations for line segment detection can be increased on the premise that event signals having the same positions (x, y) do not overlap. Alternatively, a plurality of event signals having the same positions (x, y) but different times “t” may be stored in the BEBs 223.

In the earlier example depicted in FIG. 3, the detector 224 outputs parameters including angle (θ), distance (r), latest event time (Tnew), and event duration (Duration). The angle (θ) indicates the slope of a line segment with respect to the x-axis, and the distance (r) indicates the distance (length of perpendicular line) from the upper left corner of a block to the line segment. However, the method of line segment identification is not limited to the above one. Any line segment can be identified by using other known methods (e.g., by using two parameters indicating the slope of the line segment and its relative position with respect to the block). The latest event time (Tnew) is the time corresponding to the latest of event signals used for line segment detection. The latest event time (Tnew) may be identified, for example, by extracting the latest of the times t1 to t5 of event signals E1 to E5 used for line segment detection (Tnew=t5 in the example of FIG. 3). Alternatively, since line segment detection is performed when the latest event signal is allocated to the BEBs 232, the time when the parameters 225 are outputted from the detector 224 or the time when the parameters 225 are received by the post-process 227 may be set as the latest event time (Tnew) without referencing the times of the event signals E1 to E5.

The event duration is the difference between the first time and the last time among the times t1 to t5 of the event signals E1 to E5 used for line segment detection (i.e., Duration=t5−t1 in the example of FIG. 3). Information regarding the event duration makes it possible to know the approximate time of occurrence of event signals on which line segment detection was based. For example, in a case where the event duration is significantly long, many event signals detected as noise are used for line segment detection. In such a case, it may be determined that the reliability of a line segment detected in the post-process 227 is low. Further, the detector 224 may output variance Var [t] in the time series of the time of event signal generation. In this case, if the variance Var[t] is small in a situation where the event duration is long, the post-process 227 can determine that the reliability of a detected line segment is high. Furthermore, if the variance Var[t] is large in the situation where the event duration is long, the post-process 227 can determine that the reliability of the detected line segment is low.

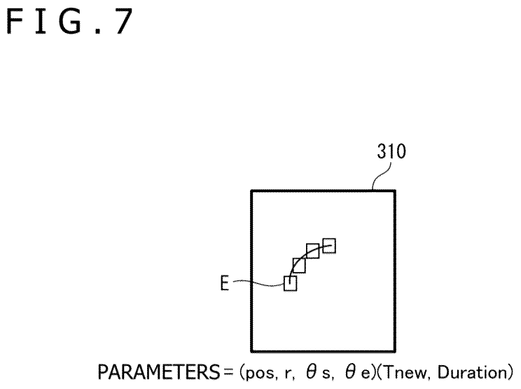

FIG. 7 is a diagram illustrating another example of detecting a shape that is formed by a set of event signal positions. In the illustrated example, a detector provided in addition to or instead of the detector 224 depicted in FIG. 1 detects a circular arc from a set of positions (x, y) of the event signals E. In this case, the detector outputs parameters including the position of the center of a circle (pos), the radius (r), the start angle (θs), the end angle (θe), the latest event time (Tnew), and the event duration (Duration). As mentioned above, a curve, such as a circular or elliptical arc formed by a set of positions of the event signals, may be detected as an intra-block relation between the positions of the event signals generated in the blocks 310. In this case too, as in the above example of line segments, curve corrections can be made in such a manner that the endpoints of curves detected in adjacent blocks overlap.

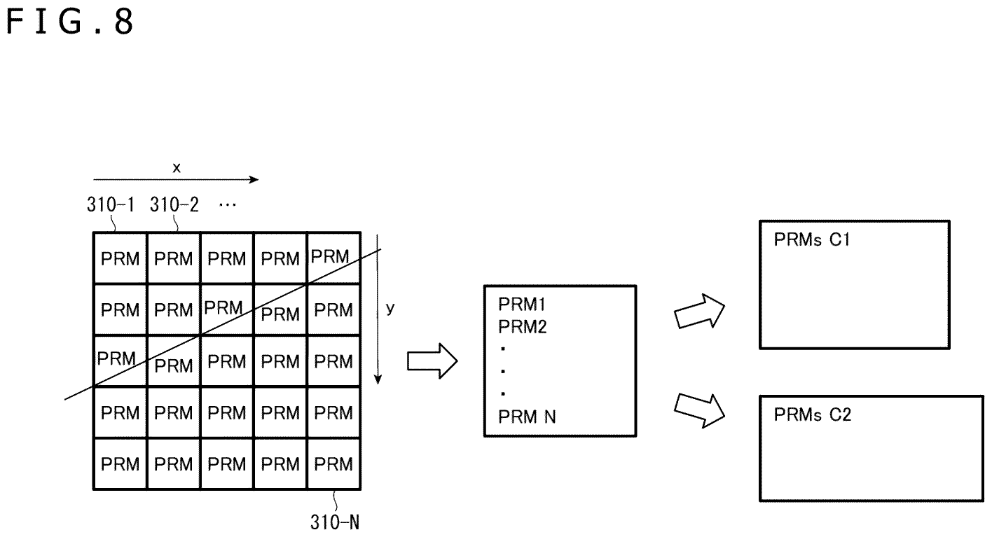

FIG. 8 is a diagram for explaining an example of processing performed using parameters representing a relation between the event signal positions within the blocks. As described above, the present embodiment is configured so as to output a parameter (PRM) for each block 310 that is obtained when the detection area of the EVS 100 is divided. For example, when parameter 1 (A, t) outputted in block 310-1 at time “t” is compared with PRM1 (A, t−Δt), which was outputted previously (At before time “t”) in the same block 310-1, it is possible to calculate the movement and rotation of a line segment detected in block 310-1. Based on the results of such a calculation, the post-process 227 is able to classify PRM1, PRM2, . . . , PRM N, which are outputted respectively from blocks 310-1, 310-2, . . . , 310-N, into clusters of parameters similar in the directions of movement and rotation, and thus identify the clusters of parameters (event line segment clusters) PRMsC1 and PRMsC2 in each of which a common line segment is estimated to have been detected. Based on the parameters classified into the same event line segment cluster, it is possible to perform calculations, such as affine transformation, on shapes extending across a plurality of blocks. Incidentally, although FIG. 8 depicts a straight line extending across a plurality of blocks, curves can also be treated as a set of line segments whose slopes change slightly in each block.

In the present embodiment, the results of the above-described processing can be used, for example, in the post-process 227 for the purpose of detecting the movement of a subject, matching a three-dimensional shape with the subject, or processing a recognizer by using machine learning. The parameters 225 are lighter than, for example, bitmapped data of the event signals, and the line segments expressed by the parameters 225 can be treated as highly accurate shapes that are not restricted by the spatial resolution of the EVS 100. Consequently, calculations, such as affine transformation, on shapes detected from the event signals can be performed rapidly and accurately.

In addition, since the present embodiment performs the processing described with reference to FIGS. 4 to 6, events generated by the edge of an originally continuous object are highly likely to be detected as a continuous line segment. Therefore, for example, more useful input can be provided to the post-process 227 described above. Further, the processing for complementing the continuity of a line segment detected in the post-process 227 can be reduced or skipped by assigning a meaning to the line segment.

### REFERENCE SIGNS LIST

100: EVS
200: Signal processing circuit
210: Memory
221: Buffer
222: Splitter
223: Block event buffer (BEB)
224: Detector
225: Parameter (PRM)
226: Correction function
227: Post-process
310: Blocks
310-1, 310-2, 310A, 310B, 310C, 310D: Block

1.-6. (canceled)

7. A computer-implemented method for processing event signals generated by an event-based vision sensor, comprising:
detecting a first intra-block relation formed by a set of positions within a first block of a first event signal, the first intra-block relation comprising one of a first line segment and a first curve, the first block and a second block resulting from division of a detection area of an event-based vision sensor, the second block being adjacent to the first block; and
correcting the first intra-block relation of the first block such that a first endpoint of the first intra-block relation overlaps with a second endpoint of a second intra-block relation of the second block of a second event signal, the second intra-block relation comprising one of a second line segment and a second curve detected in the second block.

8. The computer-implemented method of claim 7, wherein one or more of the first intra-block relation and the second intra-block relation is detected by Hough transform, and the correcting comprises moving one or more of the first endpoint and the second endpoint to respective positions that are determined using a ratio between a first vote count in a Hough transform of the first intra-block relation and a second vote count in a Hough transform of the second intra-block relation.

9. The computer-implemented method of claim 7, wherein the correcting comprises moving the one or more of the first endpoint and the second endpoint to respective positions that are determined by internal division using an inverse ratio between a smaller eigenvalue of a variance-covariance matrix of first event signal positions in the first block and a smaller eigenvalue of the variance-covariance matrix of second event signal positions in the second block.

10. The computer-implemented method of claim 7, wherein the detecting comprises detecting the first intra-block relation and detecting the second intra-block relation by selectively using one or more methods of a plurality of methods comprising a Hough transform and minimizing a sum of distances.

11. The computer-implemented method of claim 10, wherein the correcting comprises, in response to detecting the first intra-block relation and the second intra-block relation using a same method, moving the first endpoint and the second endpoint to positions determined by internal division using a ratio corresponding to the same method,

12. The computer-implemented method of claim 10, wherein the correcting comprises, in response to detecting the first intra-block relation and the second intra-block relation using different methods, moving the first endpoint and the second endpoint to a midpoint.

13. The computer-implemented method of claim 10, wherein minimizing a sum of distances comprises one of a sum of squares, an absolute sum, and a sum of p-th powers.

14. The computer-implemented method of claim 7, further comprising allocating, by a splitter, event signals to respective block event buffers for subsequent processing by a detector to detect intra-block features.

15. The computer-implemented method of claim 7, wherein:
a first event occurs in response to movement of a first object edge of the first intra-block within the first block, the first event signal being generated in response to the first event; and
a second event occurs in response to movement of a second object edge of the second intra-block within the second block, the second event signal being generated in response to the second event.

16. The computer-implemented method of claim 7, wherein a detector outputs a first set of parameters of the first intra-block relation and a second set of parameters of the second intra-block relation to a correcting function that executes the correcting.

17. A non-transitory computer-readable storage medium coupled to one or more processors and having instructions stored thereon which, when executed by the one or more processors, cause the one or more processors to perform operations for processing event signals generated by an event-based vision sensor, the operations comprising:
detecting a first intra-block relation formed by a set of positions within a first block of a first event signal, the first intra-block relation comprising one of a first line segment and a first curve, the first block and a second block resulting from division of a detection area of an event-based vision sensor, the second block being adjacent to the first block; and
correcting the first intra-block relation of the first block such that a first endpoint of the first intra-block relation overlaps with a second endpoint of a second intra-block relation of the second block of a second event signal, the second intra-block relation comprising one of a second line segment and a second curve detected in the second block.

18. The non-transitory computer-readable storage medium of claim 17, wherein one or more of the first intra-block relation and the second intra-block relation is detected by Hough transform, and the correcting comprises moving one or more of the first endpoint and the second endpoint to respective positions that are determined using a ratio between a first vote count in a Hough transform of the first intra-block relation and a second vote count in a Hough transform of the second intra-block relation.

19. The non-transitory computer-readable storage medium of claim 17, wherein the correcting comprises moving the one or more of the first endpoint and the second endpoint to respective positions that are determined by internal division using an inverse ratio between a smaller eigenvalue of a variance-covariance matrix of first event signal positions in the first block and a smaller eigenvalue of the variance-covariance matrix of second event signal positions in the second block.

20. The non-transitory computer-readable storage medium of claim 17, wherein the detecting comprises detecting the first intra-block relation and detecting the second intra-block relation by selectively using one or more methods of a plurality of methods comprising a Hough transform and minimizing a sum of distances.

21. The non-transitory computer-readable storage medium of claim 17, wherein:
a first event occurs in response to movement of a first object edge of the first intra-block within the first block, the first event signal being generated in response to the first event; and
a second event occurs in response to movement of a second object edge of the second intra-block within the second block, the second event signal being generated in response to the second event.

22. A system, comprising:
a computing device; and
a computer-readable storage device coupled to the computing device and having instructions stored thereon which, when executed by the computing device, cause the computing device to perform operations for processing event signals generated by an event-based vision sensor, the operations comprising:
detecting a first intra-block relation formed by a set of positions within a first block of a first event signal, the first intra-block relation comprising one of a first line segment and a first curve, the first block and a second block resulting from division of a detection area of an event-based vision sensor, the second block being adjacent to the first block, and
correcting the first intra-block relation of the first block such that a first endpoint of the first intra-block relation overlaps with a second endpoint of a second intra-block relation of the second block of a second event signal, the second intra-block relation comprising one of a second line segment and a second curve detected in the second block.

23. The system of claim 22, wherein one or more of the first intra-block relation and the second intra-block relation is detected by Hough transform, and the correcting comprises moving one or more of the first endpoint and the second endpoint to respective positions that are determined using a ratio between a first vote count in a Hough transform of the first intra-block relation and a second vote count in a Hough transform of the second intra-block relation.

24. The system of claim 22, wherein the correcting comprises moving the one or more of the first endpoint and the second endpoint to respective positions that are determined by internal division using an inverse ratio between a smaller eigenvalue of a variance-covariance matrix of first event signal positions in the first block and a smaller eigenvalue of the variance-covariance matrix of second event signal positions in the second block.

25. The system of claim 22, wherein the detecting comprises detecting the first intra-block relation and detecting the second intra-block relation by selectively using one or more methods of a plurality of methods comprising a Hough transform and minimizing a sum of distances.

26. The system of claim 22, wherein:
a first event occurs in response to movement of a first object edge of the first intra-block within the first block, the first event signal being generated in response to the first event; and
a second event occurs in response to movement of a second object edge of the second intra-block within the second block, the second event signal being generated in response to the second event.
